(19) United States
(12) Patent Application Publication
(10) Pub. No.: US 2016/0012581 A1
(43) Pub. Date: Jan. 14, 2016

(54) METHOD AND APPARATUS FOR DISPLAYING PATHOLOGICAL CHANGES IN AN EXAMINATION OBJECT BASED ON 3D DATA RECORDS

(71) Applicant: Siemens Aktiengesellschaft, München (DE)

(72) Inventors: Martin GRANDY, Erlangen (DE); Patric HAGMANN, Epalinges (CH); Stefan HUWER, Erlangen (DE); Gunnar KRÜGER, Watertown-Boston, MA (US); Philippe MAEDAR, Lausanne (CH); Bénédicte MARÉCHAL, Lausanne (CH); Reto MEULI, Lausanne (CH)

(21) Appl. No.: 14/754,763

(22) Filed: Jun. 30, 2015

(30) Foreign Application Priority Data
Jul. 10, 2014 (DE) 102014213409.9

(51) Int. Cl. G06T 7/00

(52) U.S. Cl. CPC G06T 7/0012; G06T 7/0081; G06T 2207/30012; G06T 2200/04

(57) ABSTRACT

A method and an apparatus are disclosed for analyzing pathological changes to anatomic areas in examination objects. In such cases, the method includes the segmentation of 3D data of the anatomic area, its standardization, comparison with a reference model and assignment of a deviation value and intensity value from an intensity scale to the anatomic area. The intensity value of the diagrammatic display of the standardized anatomic area allows the person skilled in the art to determine pathological changes to the anatomic area in a quick and cost-effective manner.

### PRIORITY STATEMENT

The present application hereby claims priority under 35 U.S.C. §119 to German patent application number DE 102014213409.9 filed Jul. 10, 2014, the entire contents of which are hereby incorporated herein by reference.

### FIELD

At least one embodiment of the present invention generally relates to a method for analyzing a 3D data record of an examination object, which allows pathological changes to anatomic areas of examination objects to be identified without in the process analyzing volumetric subregions of the anatomic area separately or in detail.

### BACKGROUND

Different methods exist for the medical diagnosis of pathologically changed tissue structures in examination objects, for instance in anatomic areas of the brain. One possible display of the changes relates to a tabular report for each structure, wherein this is segmented into sections and entries which lie outside of the reference area are marked.

A further display of pathologically changed tissue structures relates to the printing out of a reference data record and a standardized data record of the patient, wherein both data records are compared with one another based on the individual pixels.

These known methods have the disadvantageous property of generating volume effects in subregions of the anatomic areas and as a result concealing pathological changes. Furthermore, the analysis and interpretation of the results requires a significant expenditure of time, since a large number of subregions of the examined anatomic area have to be compared with one another.

The previously known methods of examining pathological changes to anatomic areas require the examination of their subregions in the majority of cases. The resulting complexity of the examination and the significant expenditure of time is therefore often perceived to be disadvantageous. The present invention therefore has the object of providing a method which allows for a simple and rapid identification of pathological changes to anatomic areas.

### SUMMARY

At least one embodiment of the invention includes a method for analyzing a 3D data record of an examination object and/or an apparatus for analyzing the 3D data record. The dependent claims define further embodiments of the present invention.

At least one embodiment of the proposed method for analyzing a 3D data record of an examination object includes firstly a segmentation of anatomic areas, of which the examination object consists. This step allows for the determination of the different anatomic areas in the 3D data record. A determination of standardized anatomic areas and a comparison with a reference model subsequently take place. The reference model in such cases includes reference variables of the different anatomic areas. A deviation value between the size of the standardized anatomic area and the size of the corresponding anatomic area in the reference model is then calculated for each of the standardized anatomic areas. This deviation value specifies the extent to which the size of the standardized anatomic area deviates from the reference variable. In a further step, the thus determined deviation value is assigned to the entire anatomic area so that the anatomic area exhibits precisely a deviation value. Precisely one intensity value is subsequently assigned to each pixel of the anatomic area, said intensity value corresponding to the deviation value.

At least one embodiment of the present invention includes an apparatus for analyzing a 3D data record, which includes a segmentation unit, a computing unit, an input device and an output device.

### BRIEF DESCRIPTION OF THE DRAWINGS

Inventive embodiments are described in detail below with reference to the figures.

FIG. 1 shows a flow diagram of the course of an embodiment of the inventive analysis method.

FIG. 2 shows a diagrammatic representation of the examination object, which is taken from a 3D data record.

FIG. 3 shows by way of example an anatomic area which is divided into pixels.

FIG. 4 shows a schematic representation of a reference model, with which a standardized anatomic area of the examination object is compared in accordance with the invention.

FIG. 5 shows in accordance with an embodiment of the invention the diagrammatic display of the standardized anatomic areas and the respective deviation from the reference model which is shown by the correspondingly colored intensities.

FIG. 6 shows an embodiment of the inventive apparatus with which the inventive method which is displayed in FIGS. 1-4 is realized technically.

### DETAILED DESCRIPTION OF THE EXAMPLE EMBODIMENTS

At least one embodiment of the proposed method for analyzing a 3D data record of an examination object includes firstly a segmentation of anatomic areas, of which the examination object consists. This step allows for the determination of the different anatomic areas in the 3D data record. A determination of standardized anatomic areas and a comparison with a reference model subsequently take place. The reference model in such cases includes reference variables of the different anatomic areas. A deviation value between the size of the standardized anatomic area and the size of the corresponding anatomic area in the reference model is then calculated for each of the standardized anatomic areas. This deviation value specifies the extent to which the size of the standardized anatomic area deviates from the reference variable. In a further step, the thus determined deviation value is assigned to the entire anatomic area so that the anatomic area exhibits precisely a deviation value. Precisely one intensity value is subsequently assigned to each pixel of the anatomic area, said intensity value corresponding to the deviation value.

One advantage of at least one embodiment of the method is that the entire anatomic area is considered to be a single object. It is in particular not necessary to analyze subregions thereof individually or separately. This reduces the complexity of the analysis and results in a time saving during the evaluation.

Furthermore, it is easy to identify for the different anatomic areas whether and how they deviate from the reference variable.

In this way the method for segmenting the 3D data record and in particular the anatomic area contained therein is preferably configured such that the 3D data is divided into pixels. The standardized size of the anatomic area is determined in that the ratio of the volume of all pixels of the anatomic area is determined for the entire volume of all pixels of the examination object.

One advantage of standardizing the size of the anatomic areas resides in specific anatomic properties, for instance different cranium variables or sex differences, being compensated.

According to a possible embodiment, the size of the standardized anatomic area is compared with the corresponding anatomic area from the reference model. The reference model is characterized in that 3D reference data contained therein consists of a plurality of segmented anatomic areas from a plurality of examination objects. Furthermore, the 3D reference data may comprise a normal distribution and can correspond for instance to a linear Gaussian regression model or a percentile model.

An advantage of the comparison with a reference model consists in pathological diseases being visible for instance by deviations in the size of the standardized anatomic area.

In one embodiment of the method, the deviation value of the standardized anatomic area is determined by the reference model, by the difference between the size of the standardized anatomic area and the size of the anatomic area being formed in the reference model and the assignment of the specific deviation value to each pixel of the anatomic area taking place such that each pixel of the anatomic area exhibits precisely one deviation value.

As a result, a pathological change in the anatomic area can be defined since the size of the deviation herewith represents a measure of the size of the atrophic/hypertrophic change.

In one possible example embodiment of the method, the deviation value is set to zero, if the anatomic area has an atrophic CSF tissue structure (CSF: cerebro-spinal fluid) or a hypertrophic GM/WM tissue structure (WM/GM: white substance/grey substance in the brain tissue). On the other hand the deviation value remains unchanged.

An advantage of this method step resides in it being possible also only to selectively consider the pathological changes. These are generally atrophic changes in CSF structures or hypertrophic changes in GM/WM tissue structures.

In one possible embodiment of the method, an offset value is added to the deviation value, if the anatomic area was not segmented or if there is no information relating to the anatomic area in the reference model.

This means that anatomic areas which cannot be compared directly with the reference model are specially identified by adding an offset value.

In a further step of the method, precisely one intensity value is assigned to each pixel of the standardized anatomic area, said intensity value corresponding to the deviation value of the standardized anatomic area of the reference model, so that all pixels of an anatomic area represent the same change and these can be easily identified.

An advantage of this step resides in it being possible to assign a measure of the pathological change to the anatomic area in a diagrammatic display and this being directly displayable in the image.

In one possible embodiment of the method, the pixels are displayed diagrammatically with the associated intensity value, wherein the displayed region of the pixels consists of a cross-sectional plane of the anatomic area.

This means that the entire anatomic area is displayed diagrammatically such that a measure of a pathological change in the anatomic area corresponds to the intensity.

At least one embodiment of the present invention includes an apparatus for analyzing a 3D data record, which includes a segmentation unit, a computing unit, an input device and an output device.

In this way the segmentation unit has the function of dividing an entire examination object into a plurality of anatomic areas.

The computing unit has the function of standardizing sizes of the anatomic areas and comparing the same with a reference model. It determines a deviation value from this comparison. The computing unit finally assigns an intensity value to the determined deviation value for diagrammatic display purposes.

Furthermore, the apparatus includes an input device, which is used as an input interface for the user. The output device reproduces the intensity values diagrammatically.

The user of the method is thus advantageously able to obtain information relating to atrophic or hypertrophic changes in entire anatomic areas in very short time. It is in particular not necessary to individually analyze a number of partial structures of an area. This produces a time saving when evaluating atrophic or hypertrophic changes in an anatomic area. Typical examples of atrophic changes are Alzheimer's or dementia.

Furthermore an embodiment of the proposed method includes a cost-effective examination possibility in respect of pathological changes to anatomic areas.

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

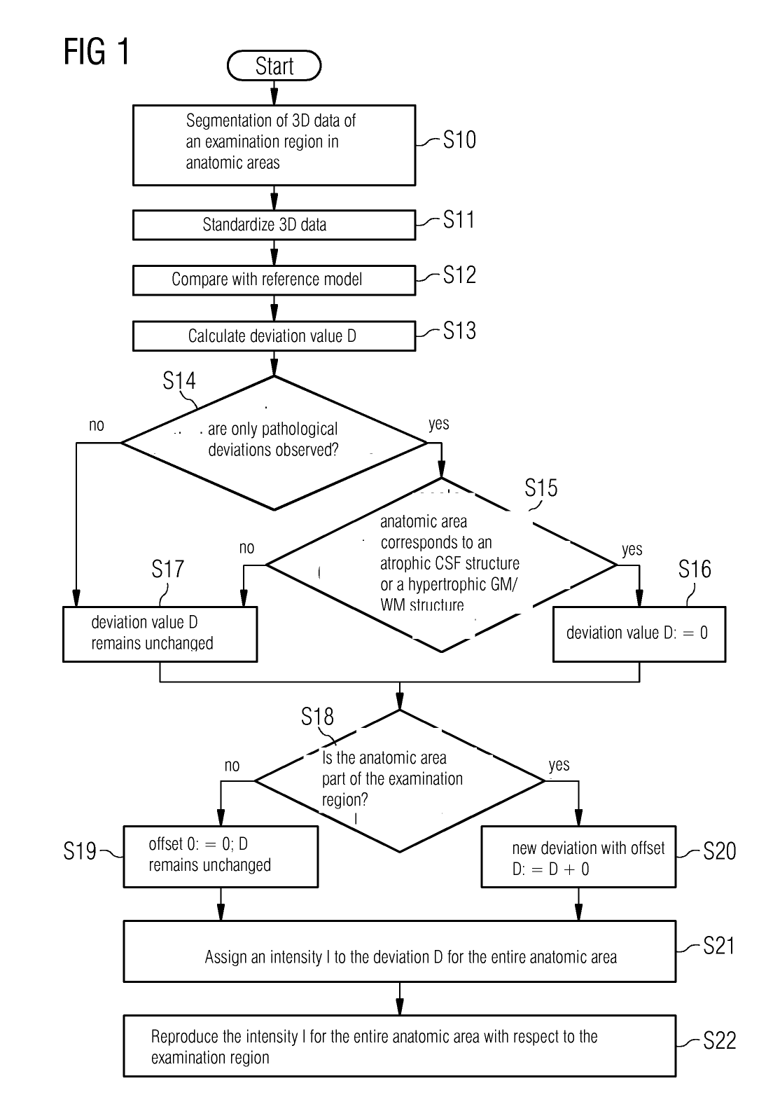

FIG. 1 shows the method for analyzing pathological changes in a flow chart. An embodiment of the inventive method is structured such that in the first step S10 a segmentation of a 3D data record takes place with the aid of known segmentation algorithms. In one possible example embodiment a source of the 3D data record may be a T1 weighted (T1w) magnetic resonance (MW) brain volume recording. In another example embodiment, the 3D data record can originate from an MR recording of any tissue structure in a human body.

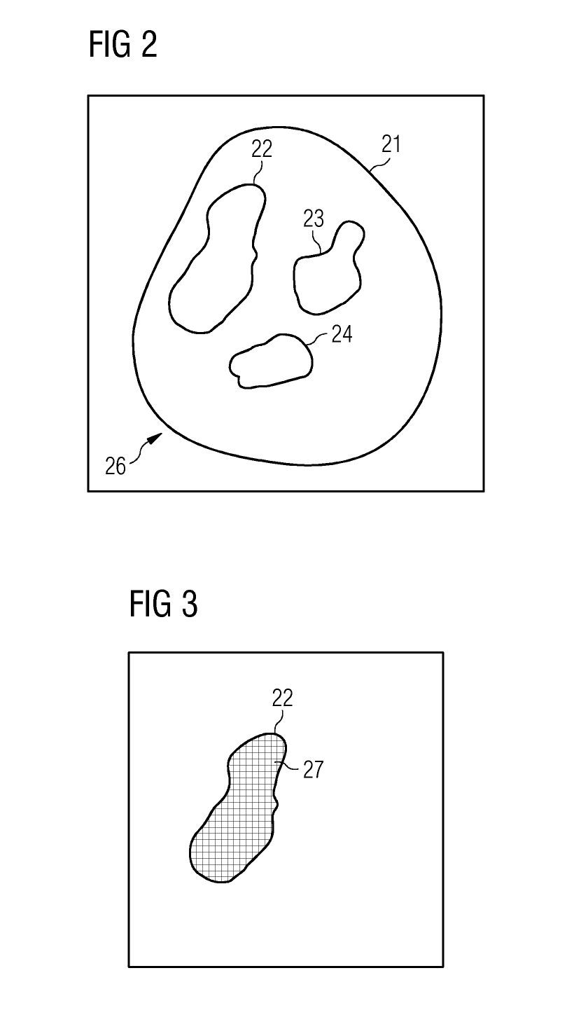

FIG. 2 shows how an examination object 26 comprising the 3D data record is divided into different anatomic areas of interest (22, 23, 24).

In this example embodiment the examination object 26 consists by way of example of different anatomic areas (22, 23, 24) of a brain and the cranial bone 21. The anatomic areas (22, 23, 24) can thus be examined in accordance with the proposed method.

In FIG. 1 in the next step S11, a standardization of the entire volume of each anatomic area is performed, by the ratio of the volume of all pixels of an anatomic area being calculated to form the overall volume of all pixels of the examination object.

This is shown by way of example in greater detail in FIG. 3. The ratio of the volume of all pixels 27 of the anatomic area 22 is calculated to form the overall volume of all pixels of the examination object 26 in FIG. 1.

FIG. 5 shows the result of the standardization. Standardized anatomic areas (40, 41, 42), which differ from the original anatomic areas on account of their size, thus result. This step is required in order to standardize the original anatomic areas and to be able to compare them with a reference model.

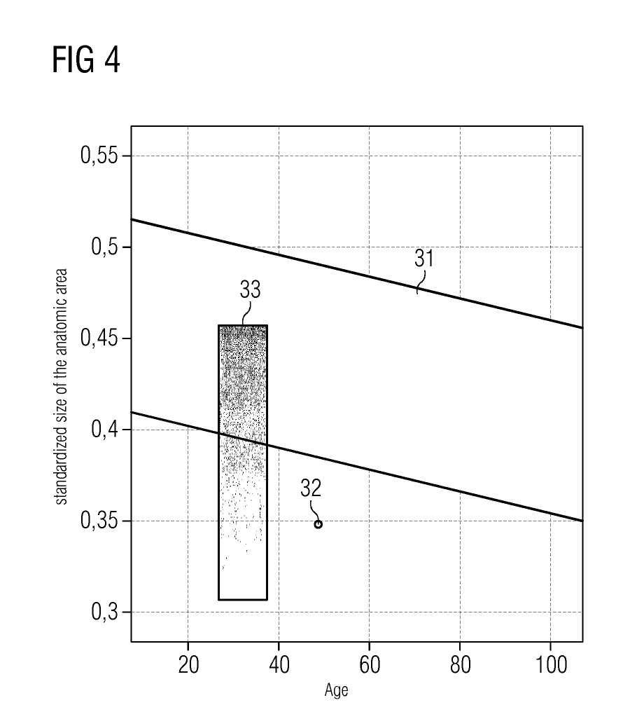

FIG. 4 shows a diagram of the reference model 31, which is used for the comparison with a standardized anatomic area. This reference model 31 includes 3D data comprising a plurality of non-pathological examination objects and anatomic areas of a different age and corresponds for instance to a Gaussian or percentile reference model with a standard distribution. The diagram represents the sizes of the non-pathologically referenced anatomic areas (Y-axis) as a function of the age of the examination objects (X-axis).

In FIG. 4, a standardized anatomic area is recorded in the diagram in accordance with the age of the examination object and the size of the standardized area. A deviation value 32, which can either lie inside of or outside of the reference model, results therefrom.

In the example embodiment in FIG. 4, the deviation value 32 of the standardized anatomic area lies below the reference area, i.e. the standardized anatomic area has a smaller size by comparison with the reference model 31. According to the inventive method, an intensity value is now assigned to the deviation value 32 of the standardized anatomic area, said intensity value being taken from the intensity scale 33. The value of the intensity is in this case a measure of the deviation from the reference model 31.

FIG. 1 shows how, in a further step S12, the standardized 3D data is compared with the reference model. The deviation value D is then determined in step S13, said deviation value D corresponding to a deviation in the standardized anatomic area from the associated anatomic area in the reference model. The one deviation value D is assigned here to the overall anatomic area.

This means that the anatomic area is considered as a whole and the separate analysis of subregions is not required. This is advantageous in that the person skilled in the art obtains an overview of pathological changes in the examination region in a quick and simple manner. In the next step S14 of the method, it is determined whether these are only pathological deviations. If this is the case, the method determines in step S15 whether this is an atrophic CSF structure (CSF: cerebro-spinal fluid) or a hypertrophic GM/WM structure (WM/GM: white substance/grey substance in the brain tissue). If this is the case, the deviation value D is set to zero. This corresponds to step S16. If in the other case this is not an atrophic CSF structure or a hypertrophic CM/WM structure, the deviation value D in step S17 remains unchanged.

If no pathological deviations are observed, the deviation value D likewise remains unchanged.

In the next step S18, the method determines whether the anatomic area is part of the examination region. If this case S20 occurs, an offset O is added to the deviation value D. In the event that the anatomic area is not part of the examination region, the deviation D remains unchanged. This corresponds to step S19.

FIG. 5 shows by way of example an anatomic area which is not part of the examination region. In this example embodiment, this is the cranial bone (21) in which the standardized anatomic areas (40, 41, 42) are disposed. The standardized anatomic areas (40, 41, 42) are here part of the examination region, the cranial bone 21 is however not part of the examination region.

In the next step S21 in FIG. 1, an intensity value I is assigned to the deviation value D for the diagrammatic display of the standardized anatomic area, said intensity value corresponding to the extent of the deviation.

In the subsequent step S22, the method then forms the intensity I of the anatomic area together with the intensity of the examination object, in which the standardized anatomic area is disposed.

In FIG. 5, the standardized anatomic areas (40, 41, 42) in the examination object 26 are displayed diagrammatically, wherein the assigned intensity values of each area correspond to the deviation from the reference model. In this example embodiment, a large deviation from the reference model corresponds to a light value, a dark value corresponds to a minor or no deviation.

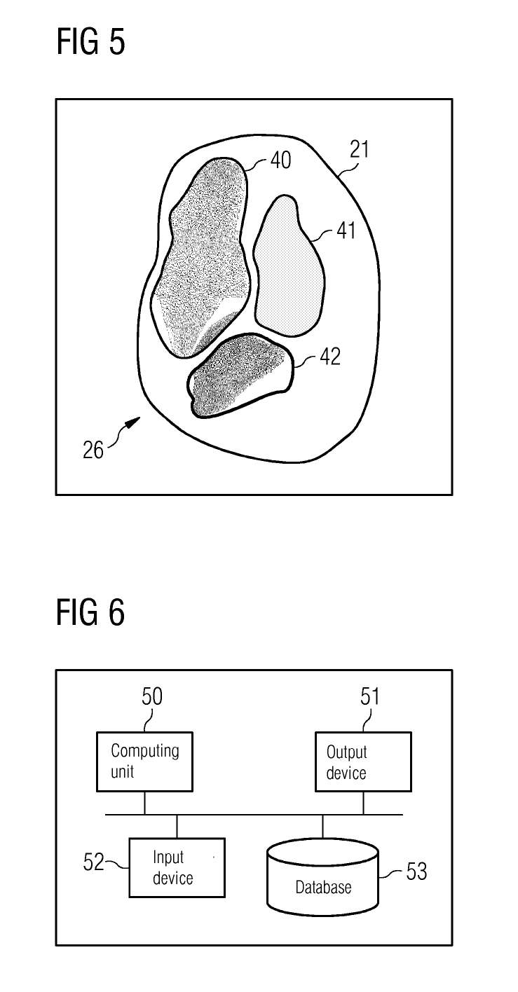

FIG. 6 displays an apparatus for the technical implementation of the proposed method.

Here the tasks of the computing unit 50 include the implementation of the above method steps. The computing unit 50 is connected to a database 53, which includes the data of the reference model, which is used for comparison with the examination objects.

In addition, the apparatus from FIG. 6 includes an input device 52, which is used as an input interface of the user and an output device 51, which is used for the diagrammatic display of the intensity values of the standardized anatomic areas.

The proposed method provides the person skilled in the art with a method of obtaining a rapid overview of atrophic or hypertrophic changes to tissue structures of an entire anatomic area in a simple manner. In such cases it is no longer necessary to individually analyze subregions of the area which represents a time saving with respect to the already existing method.

Since the method builds on the display of standardized tissue structures with reference to their size, volume effects or spatial misalignments are corrected which likewise contributes to the simplicity of the method.

Since the method involves an analysis of the quantitative changes to anatomic areas compared with a fixed reference model, the person skilled in the art can easily determine temporal changes to the pathological structures of the examination object.

The method also builds on already existing 3D data records, which renders the data analysis cost-effective in terms of implementation and operation.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for analyzing a 3D data record of an examination object, comprising:
segmenting the 3D data record of the examination object to determine different anatomic areas in the 3D data record;
determining standardized anatomic areas by standardizing sizes of the different anatomic areas;
comparing the sizes of the different standardized anatomic areas with a reference model including reference variables of the different anatomic areas; and
for each of the standardized anatomic areas,
determining a deviation value, indicating how the size of the respective standardized anatomic area deviates from the associated reference variable,
assigning, to all pixels of a respective anatomic area, a deviation value, so that all pixels of an anatomic area have the same deviation value, and
assigning, to all pixels of the respective anatomic area, an intensity value for diagrammatic display which corresponds to the deviation value.

2. The method of claim 1, wherein,
all of the different anatomic areas, contained in the 3D data record of the examination object, are divided into a plurality of pixels, and
the standardization of a respective one of the different anatomic areas takes place such that the ratio of the volume of all pixels of the respective one of the different anatomic areas with an overall volume of all pixels of the examination object is determined.

3. The method of claim 1, wherein,
the size of the standardized anatomic area is compared with the corresponding anatomic area from a reference model, including a statistical normal distribution and including 3D reference data from a plurality of segmented anatomic areas comprising a plurality of examination objects.

4. The method of claim 3, wherein,
the deviation value of the standardized anatomic area is determined from the reference model such that the difference between the size of the standardized anatomic area and the size of the anatomic area is calculated in the reference model, and
wherein the assignment of the deviation value to each pixel of the respective anatomic area takes place such that each pixel of the respective anatomic area exhibits precisely one deviation value.

5. The method of claim 1, wherein,
the deviation value is set to zero if the respective one of the different anatomic areas includes an atrophic cerebro-spinal fluid tissue structure or a hypertrophic grey mass/white mass tissue structure, and
the deviation value remains unchanged if the respective one of the different anatomic areas neither includes an atrophic cerebrospinal fluid tissue structure nor a hypertrophic GM/WM tissue structure.

6. The method of claim 3, further comprising:
an adding of an offset value to the deviation value if the respective one of the different anatomic areas was not segmented, and
the adding of an offset value to the deviation value if no information relating to the respective one of the different anatomic areas exists in the reference model.

7. The method of claim 2, wherein,
precisely one intensity value is assigned to each pixel of the standardized anatomic area, said intensity value corresponding to the deviation value of the standardized anatomic area from the reference model.

8. The method of claim 1, wherein,
part of the pixels is displayed diagrammatically with the intensity value, wherein the part of the pixels includes a cross-sectional plane of the anatomic area.

9. An apparatus for analyzing a 3D data record of an examination object, comprising:
a computing unit, embodied to segment 3D data of an examination object and to determine standardized anatomic areas by standardizing a size of different anatomic areas and to, for each of the standardized anatomic areas,
compare sizes of the standardized anatomic areas with a reference model,
determine a deviation value between the size of the standardized anatomic areas and the associated reference variable,
assign the deviation value to all pixels of a respective one of the standardized anatomic areas, and
assign an intensity value, which corresponds to the deviation value, to all pixels;
a database, embodied to store the 3D data;
an input device, embodied as a user-input interface; and
an output device, embodied to display the intensity values diagrammatically.

10. An apparatus for analyzing a 3D data record of an examination object, comprising:
a computing unit, embodied to segment 3D data of an examination object and to determine standardized anatomic areas by standardizing a size of different anatomic areas and to, for each of the standardized anatomic areas,
compare sizes of the standardized anatomic areas with a reference model,
determine a deviation value between the size of the standardized anatomic areas and the associated reference variable,
assign the deviation value to all pixels of a respective one of the standardized anatomic areas, and
assign an intensity value, which corresponds to the deviation value, to all pixels;
a database, embodied to store the 3D data;
an input device, embodied as a user-input interface; and
an output device, embodied to display the intensity values diagrammatically, wherein the apparatus is configured to implement the method of claim 1.

11. The method of claim 2, wherein,
the size of the standardized anatomic area is compared with the corresponding anatomic area from a reference model, including a statistical normal distribution and including 3D reference data from a plurality of segmented anatomic areas comprising a plurality of examination objects.

12. The method of claim 11, wherein,
the deviation value of the standardized anatomic area is determined from the reference model such that the difference between the size of the standardized anatomic area and the size of the anatomic area is calculated in the reference model, and
wherein the assignment of the deviation value to each pixel of the respective anatomic area takes place such that each pixel of the respective anatomic area exhibits precisely one deviation value.

13. The method of claim 4, wherein,
the deviation value is set to zero if the respective one of the different anatomic areas includes an atrophic cerebro-spinal fluid tissue structure or a hypertrophic grey mass/white mass tissue structure, and
the deviation value remains unchanged if the respective one of the different anatomic areas neither includes an atrophic cerebrospinal fluid tissue structure nor a hypertrophic GM/WM tissue structure.

14. The method of claim 12, wherein,
the deviation value is set to zero if the respective one of the different anatomic areas includes an atrophic cerebro-spinal fluid tissue structure or a hypertrophic grey mass/white mass tissue structure, and
the deviation value remains unchanged if the respective one of the different anatomic areas neither includes an atrophic cerebrospinal fluid tissue structure nor a hypertrophic GM/WM tissue structure.

15. The method of claim 14, further comprising:
an adding of an offset value to the deviation value if the respective one of the different anatomic areas was not segmented, and
the adding of an offset value to the deviation value if no information relating to the respective one of the different anatomic areas exists in the reference model.

16. The method of claim 15, wherein,
precisely one intensity value is assigned to each pixel of the standardized anatomic area, said intensity value corresponding to the deviation value of the standardized anatomic area from the reference model.

17. The method of claim 16, wherein,
part of the pixels is displayed diagrammatically with the intensity value, wherein the part of the pixels includes a cross-sectional plane of the anatomic area.
